(19) United States
(12) Patent Application Publication
(10) Pub. No.: US 2020/0000113 A1
(43) Pub. Date: Jan. 2, 2020

(54) CONFIGURABLE FRUIT RIPENING DEVICE

(71) Applicant: Walmart Apollo, LLC, Bentonville, AR (US)

(72) Inventors: Jesse Lee Eaton, Springdale, AR (US); David Blair Brightwell, Bentonville, AR (US); Greg Bryan, Centerton, AR (US); Jeffrey Kerbs, Bentonville, AR (US); Cristy Crane Brooks, Cassville, MO (US)

(21) Appl. No.: 16/449,262

(22) Filed: Jun. 21, 2019

Related U.S. Application Data
(60) Provisional application No. 62/691,434, filed on Jun. 28, 2018.

(51) Int. Cl. A23B 7/152; A23L 3/3445; F25D 17/04; F25D 25/02

(52) U.S. Cl. CPC A23B 7/152; A23L 3/3445; A23V 2002/00; F25D 25/025; F25D 17/042

(57) ABSTRACT

Examples provide a fruit ripening drawer for ripening fruit at variable rates in multiple air-tight compartments staggering completion of fruit ripening within each compartment. A user selects a level of ripeness and a date for consumption for fruit within each compartment. A calculation component calculates customized settings for each compartment, including an amount of ethylene gas, temperature, duration of gas exposure and/or humidity within each compartment. A metering device delivers the calculated amount of ethylene gas into each compartment. A thermostat device controls the temperature and/or humidity within each compartment. The fruit ripening drawer controls conditions within each compartment and duration of ethylene gas exposure to accelerate or delay fruit ripening within each compartment based on the user-selected level of ripeness and consumption date for fruit in each compartment. The fruit ripening drawer is a stand-alone counter-top device. The fruit ripening drawer can be incorporated within a temperature-controlled appliance.

### BACKGROUND

Some produce, such as bananas, is frequently harvested and distributed in a mature but un-ripe state while the fruit is still green. The produce is exposed to ethylene gas to initiate ripening at a point in the supply chain prior to shipment or delivery to a market or store for consumption. During this process, containers of un-ripe produce are exposed to an amount of ethylene gas sufficient to at least partially ripen the fruit upon arrival at the market or store. Once ripening begins, the bananas continue to ripen which results in some quantity of fruit wasted due to continued ripening prior to purchase by consumers and over-ripening post-sale. Moreover, consumers making infrequent shopping trips can purchase smaller quantities of produce to prevent waste/over-ripening of un-consumed fruit. However, this may result in the consumer having insufficient produce or running out of produce prior to their next planned shopping trip or necessitating more frequent shopping trips to obtain additional produce. This is an inconvenient and time-consuming process.

### SUMMARY

Some examples provide a system for location-based fruit ripening. A fruit ripening drawer includes a first compartment and a second compartment stores unripe fruit. A set of ethylene gas supply lines connects an ethylene gas metering device to the compartments. The ethylene gas metering device includes a re-usable ethylene gas cartridge. A data storage device stores a set of per-compartment fruit ripening configurations for customizing ripening of fruit in each compartment in the fruit ripening drawer. The set of per-compartment fruit ripening configurations includes a first level of ripeness, a first consumption date, a second level of ripeness and a second consumption date. A control device includes a memory and at least one processor communicatively coupled to the memory. A controller component activates the gas metering device to release a first quantity of ethylene gas into the first compartment at a first temperature to complete ripening of a first quantity of unripe fruit in the first compartment to the first level of ripeness on the first consumption date. The controller component activates the gas metering device to release a second quantity of ethylene gas into the second compartment at a second temperature to complete ripening of a second quantity of unripe fruit in the second compartment to the second level of ripeness on the second consumption date.

Other examples provide a computer-implemented method for customized fruit ripening in accordance with user-selected parameters. A user interface device receives a set of per-compartment fruit ripening configurations for each compartment in a plurality of compartments associated with a fruit ripening drawer. The set of per-compartment fruit ripening configurations includes a first set of user-selected configurations for a first compartment and a second set of user-selected configurations for a second compartment. The first set of user-selected configurations includes a first level of ripeness and a first consumption date identifying a date at which unripe fruit in the first compartment is scheduled to achieve the first level of ripeness. The unripe fruit is fruit previously unexposed to ethylene gas. The second set of user-selected configurations includes a second level of ripeness and a second consumption date at which the unripe fruit in the second compartment is scheduled to achieve the second level of ripeness. A calculation component calculates a first quantity of ethylene gas, a first temperature and a first humidity value to ripen fruit in the first compartment to the first level of ripeness on the first consumption date. The calculation component calculates a second quantity of ethylene gas, a second temperature and a second humidity value to ripen fruit in the second compartment to the second level of ripeness on the second consumption date. A thermostat device sets a temperature and humidity within the first compartment to the first temperature and the first humidity. The thermostat device sets a temperature and humidity within the second compartment to the second temperature and the second humidity. A controller component activates an ethylene gas metering device to release the first quantity of ethylene gas into the first compartment to achieve the first level of ripeness of fruit in the first compartment on the first consumption date and the second quantity of ethylene gas into the second compartment to achieve the second level of ripeness of the fruit in the second compartment on the second consumption date.

Still other examples provide a configurable fruit ripening device. The device includes a plurality of compartments for storing unripe fruit. Unripe fruit is fruit previously unexposed to ethylene gas. The plurality of compartments includes a first compartment and a second compartment. A set of ethylene gas supply lines connects an ethylene gas metering device to the set of compartments. A control device includes a memory and a processor communicatively coupled to the memory. A controller component activates the ethylene gas metering device to release a first quantity of ethylene gas into the first compartment for a first exposure time to accelerate ripening of fruit in the first compartment to achieve a first user-selected level of ripeness of a first quantity of fruit on a first day. The controller component activates the ethylene gas metering device to release a second quantity of ethylene gas into the second compartment for a second exposure time to accelerate ripening of a second quantity of fruit in the second compartment to achieve a second user-selected level of ripeness on a second day.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a system for customizing fruit ripening on a per-day basis via a configurable fruit ripening drawer.

FIG. 2 is an exemplary block diagram illustrating a fruit ripening drawer incorporated within a refrigeration appliance.

FIG. 3 is an exemplary block diagram illustrating a fruit ripening system including a fruit ripening drawer inside a refrigerator.

FIG. 4 is an exemplary block diagram illustrating a stand-alone fruit ripening drawer.

FIG. 5 is an exemplary block diagram illustrating a stand-alone fruit ripening drawer on a counter-top.

FIG. 6 is an exemplary block diagram illustrating a plurality of compartments within a fruit ripening drawer.

FIG. 7 is an exemplary block diagram illustrating a plurality of compartments within a fruit ripening drawer.

FIG. 8 is an exemplary block diagram illustrating a plurality of compartments connected to a metering device within a fruit ripening drawer.

FIG. 9 is an exemplary block diagram illustrating a set of sensor devices associated with compartments in a fruit ripening drawer.

FIG. 10 is an exemplary block diagram illustrating a controller component.

FIG. 11 is an exemplary block diagram illustrating a database storing fruit ripening data.

FIG. 12 is an exemplary block diagram illustrating levels of ripeness for bananas.

FIG. 13 is an exemplary block diagram illustrating a set of temperature settings for ripening fruit.

FIG. 14 is an exemplary flow chart illustrating operation of the computing device to customize settings within a plurality of compartments for ripening fruit at variable rates.

FIG. 15 is an exemplary flow chart illustrating operation of the computing device to monitor conditions within fruit ripening compartments and output maintenance notifications to a user based on detected conditions.

FIG. 16 is an exemplary flow chart illustrating operation of the computing device to increase or decrease ethylene gas content within each compartment to accelerate or delay fruit ripening within each compartment.

Corresponding reference characters indicate corresponding parts throughout the drawings.

### DETAILED DESCRIPTION

Referring to the figures, examples of the disclosure enable a fruit ripening device for home/residential use having two or more compartments for staggered ripening of small quantities of fruit. In some examples, the fruit ripening device includes seven compartments for ripening one or more bananas in each compartment to a user-selected level of ripening for consumption on each day of the week. The device ripens only as much fruit as a user desires for consumption on each day to prevent user purchase or consumption of over-ripened or under-ripened fruit while reducing food waste.

Other examples provide a customizable per-compartment fruit ripening drawer enabling a user to select a desired level of ripening and a desired date of consumption for the produce in each compartment. A user purchases unripe fruit for placement within the fruit ripening drawer which only ripens the actual quantity of fruit (number of bananas) the user plans to eat on each day. This enables a user to more accurately determine the ripeness levels of produce prior to consumption while reducing produce waste due to over-ripening after purchase of the produce. Moreover, the user reduces or avoids consumption of fruit which is under-ripe or over-ripe based on the user's taste/personal preference.

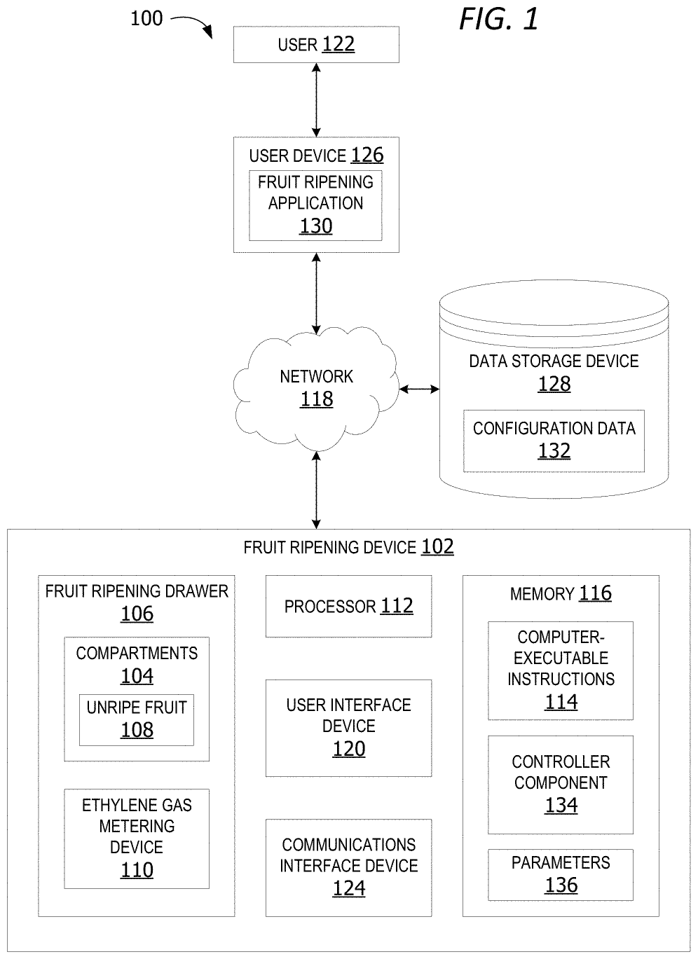

Referring again to FIG. 1, an exemplary block diagram illustrates a system 100 for customizing fruit ripening on a per-day basis via a configurable fruit ripening drawer 106. In the example of FIG. 1, the fruit ripening device 102 represents a plurality of compartments 104 within a fruit ripening drawer 106 for storing unripe fruit 108. An ethylene gas metering device 110 delivers ethylene gas (C₂H₄) into each compartment to accelerate ripening of fruit in each compartment at variable rates for consumption on different days of the week. The fruit ripening drawer 106 can be utilized to ripen fruit, such as, but not limited to, bananas, avocadoes, mangoes, apples, papaya, tomatoes and/or any other type of mature but unripe fruit which can be ripened via exposure to ethylene gas.

The unripe fruit 108 is produce which has never been exposed to ethylene gas. The unripe fruit 108 is completely unripe or only partially ripe (ripening is incomplete) such that the fruit is unsuitable for consumption in its current unripe/partially ripe state.

The fruit ripening device 102 can include a processor 112 for executing computer-executable instructions 114 (e.g., as application programs, operating system functionality, or both) to implement the operations and functionality associated with the fruit ripening device 102.

The processor 112 includes any quantity of processing units and is programmed to execute the computer-executable instructions 114. The computer-executable instructions 114 can be performed by the processor 112 or by multiple processors within the fruit ripening device 102 or performed by a processor external to the fruit ripening device 102. The processor 112 can represent a single processor, a group of processing units or other computing devices. In some examples, the processor 112 is programmed to execute instructions such as those illustrated in the figures (e.g., FIG. 1).

The fruit ripening device 102 optionally includes one or more computer-readable media such as the memory 116. The memory 116 includes any quantity of media associated with or accessible by the fruit ripening device 102. The memory 116 can be internal to the fruit ripening device 102 (as shown in FIG. 1), external to the fruit ripening device (not shown), or both (not shown). In some examples, the memory 116 includes read-only memory and/or memory wired into the fruit ripening device 102.

The memory 116 stores data, such as one or more applications. The applications, when executed by the processor 112, operate to perform functionality on the fruit ripening device 102. The applications can communicate with counterpart applications or services such as web services accessible via a network 118. For example, the applications can represent downloaded client-side applications that correspond to server-side services executing in a cloud.

In other examples, the fruit ripening device includes a user interface device 120. The user interface device 120 includes a graphics card for displaying data to a user 122 operating the fruit ripening device 102. The graphics card can also receive data from the user 122. The user interface device 120 can also include computer-executable instructions (e.g., a driver) for operating the graphics card. Further, the user interface device 120 can include a display (e.g., a touch screen display, projected display and/or natural user interface) and/or computer-executable instructions (e.g., a driver) for operating the display. The user interface device 120 can also include one or more of the following to provide data to the user or receive data from the user: speakers, a sound card, a camera, a microphone, a vibration motor, one or more accelerometers, a BLUETOOTH® brand communication module, global positioning system (GPS) hardware, and a photoreceptive light sensor. For example, the user can enter fruit ripening configuration settings verbally (audio input), textually (text input) and/or kinesthetically (haptic input).

The network 118 is implemented by one or more physical network components, such as, but without limitation, routers, switches, network interface cards (NICs), and other network devices. The network 118 can be any type of network for enabling communications with remote computing devices, such as, but not limited to, a local area network (LAN), a subnet, a wide area network (WAN), a wireless (Wi-Fi) network, or any other type of network. In this example, the network 118 is a WAN, such as the Internet. However, in other examples, the network 118 is a local or private LAN.

In some examples, the system 100 optionally includes a communications interface component 124. The communications interface component 124 includes a network interface card and/or computer-executable instructions (e.g., a driver) for operating the network interface card. Communication between the fruit ripening device 102 and other devices, such as but not limited to a user device 126 and/or a remote data storage device 128, can occur using any protocol or mechanism over any wired or wireless connection. In some examples, the communications interface component 124 is operable with short range communication technologies such as by using near-field communication (NFC) tags.

The user device 126 represents any computing device executing computer-executable instructions. The user device 126 can be implemented as a mobile computing device, such as, but not limited to, a wearable computing device, a mobile telephone, laptop, tablet, computing pad, netbook, gaming device, and/or any other portable device. The user device 126 includes at least one processor and a memory for executing applications, such as, but not limited to, a fruit ripening application 130. The fruit ripening application 130 is an application for remotely controlling the fruit ripening device 102 via the Internet of Things (IoT). The user 122 can select fruit ripening configurations for each of the compartments 104. The configurations can include user-selected date of consumption for fruit in each compartment, a level of ripeness for fruit in each compartment and/or quantity of fruit in each compartment.

The user-selected date of consumption is the date and/or time at which the user wants unripe type of fruit to be ripened to a desired level of ripeness (ready to eat). The level of ripeness indicates magnitude of ripeness. For example, a banana can be completely green, half green and half yellow, mostly yellow with green tips, completely yellow with no green, yellow with brown speckling, etc. The type of fruit identifies kind. The type of fruit can include a banana, mango, avocado, or any other type of fruit which is ripened via ethylene gas exposure.

In one example, if the user selects a date of consumption in six days for bananas having a level of ripeness in which the banana is yellow with green tips, the controller component calculates the amount of ethylene gas, time of exposure, temperature and/or humidity level which will accelerate ripening of the banana to the desired level of ripeness on the sixth day after initial placement of the fruit into the fruit ripening device.

In the example above, the date of consumption is set by the user prior to beginning ripening of fruit in a compartment. In other examples, the user can dynamically change the date of consumption after ripening has already begun. For example, if unripe fruit is placed into the fruit ripening device on a Monday and the user set the date of consumption for Friday (four days later) and the next day changes/resets the date of consumption to Thursday (one day early), the system automatically recalculates an updated temperature, humidity and/or ethylene gas exposure time to accelerate ripening of the fruit to ensure the fruit reaches the desired level of ripeness on Thursday instead of Friday.

In still another example, if the fruit placed into the fruit ripening device is pre-exposed to ethylene gas but not fully ripe and the user sets a consumption date for the next day, the controller component analyzes sensor data received from a sensor device to determine the current level of ripeness of the fruit. The system then calculates temperature and/or humidity levels for the ripening compartment to accelerate ripening to the desired level of ripeness within the twenty-four-hour ripening time selected by the user. The system can also release additional ethylene gas into the compartment to accelerate ripening to the desired level within the user-selected ripening time.

The user device 126 can also include a user interface component. In some examples, the user 122 selects fruit ripening configurations for each compartment via the user interface component. In other words, the user 122 utilizes the fruit ripening application 130 to control fruit ripening in each compartment. The user utilizes the user interface component to provide the user-selected fruit ripening configurations for each compartment.

The system 100 can optionally include a data storage device 128 for storing data, such as, but not limited to configuration data 132. The configuration data 132 is data associated with user-selected configurations for each compartment in the fruit ripening device 102. The configuration data 132 is provided by the user 122 via the user interface device 120 on the fruit ripening device 102 or via the fruit ripening application 130 running on the user device 126.

The data storage device 128 can include one or more different types of data storage devices, such as, for example, one or more rotating disks drives, one or more solid state drives (SSDs), and/or any other type of data storage device. The data storage device 128 in some non-limiting examples includes a redundant array of independent disks (RAID) array. In other examples, the data storage device 128 includes a database.

The data storage device 128 in this example is accessed via the network 118, such as a remote data storage device, a data storage in a remote data center, or a cloud storage. In other examples, the data storage device 128 is included within the fruit ripening device 102 or the user device 126.

The memory 116 in some examples stores one or more computer-executable components. Exemplary components include a controller component 134. The controller component 134 activates the ethylene gas metering device 110 to release a first quantity of ethylene gas into a first compartment at a first temperature to accelerate ripening of the fruit in the first compartment to the user-selected level of ripeness on a first consumption date. The controller component 134 activates the ethylene gas metering device 110 to release a second quantity of ethylene gas into a second compartment at a second temperature calculated to accelerate ripening of fruit in the second compartment to the selected level of ripeness on the second consumption date.

The metering device routes ethylene gas to each compartment via the ethylene gas supply lines connecting the metering device to each compartment. To stop the flow of ethylene gas to a selected chamber, the metering device closes a port or aperture associated with one end of the ethylene gas supply line to stop ethylene gas from flowing through the ethylene gas supply line to the selected compartment in the fruit ripening drawer 106.

In some non-limiting examples, the controller component 134 utilizes fruit ripening parameters 136 to calculate the settings/conditions within each compartment necessary to ripen the fruit in each compartment for consumption on the user-selected date. The settings/conditions calculated by the controller component 134 includes the quantity of ethylene gas to be released into each compartment, the duration of time fruit in each compartment should be exposure to the ethylene gas, the temperature within each compartment and/or the humidity levels within each compartment. The controller component 134 utilizes the calculated settings to control/activate the ethylene gas metering device 110 to meter release of ethylene gas into each compartment. In other words, the ethylene gas metering device 110 routes ethylene gas into one or more compartments within the fruit ripening device.

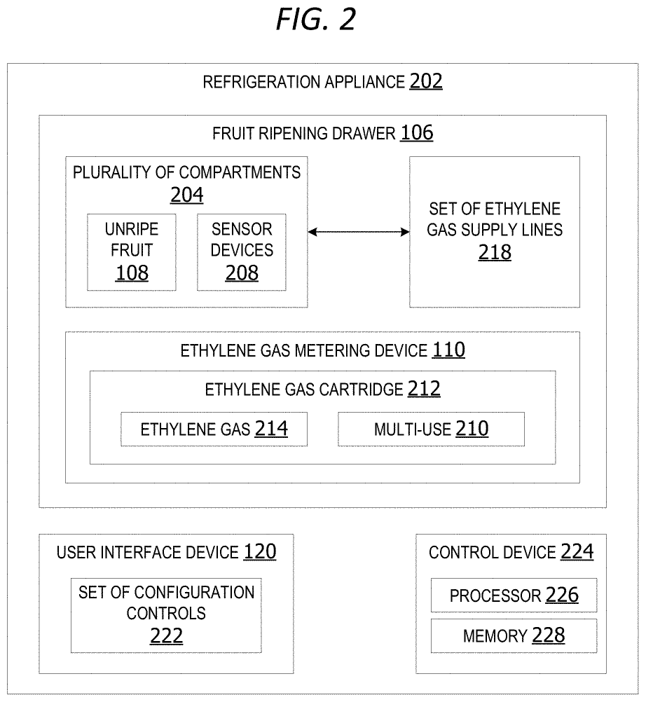

FIG. 2 is an exemplary block diagram illustrating a fruit ripening drawer 106 incorporated within a refrigeration appliance 202. The fruit ripening drawer 106 can be attached within an existing drawer, such as a crisper drawer or produce drawer. In other examples, the fruit ripening drawer 106 is attached in place of an existing drawer in a refrigerator, such as, but not limited to, the crisper drawer.

The fruit ripening drawer 106 includes a plurality of compartments 204 for storing unripe fruit 108. Unripe fruit 108 is fruit previously unexposed to ethylene gas. The plurality of compartments 204 includes one or more sensor devices 208 for monitoring conditions within each compartment. The conditions within each compartment can include presence/amount of ethylene gas, temperature within each compartment, humidity levels within each compartment, weight/quantity of fruit in each compartment and/or appearance/color of fruit in each compartment.

The one or more sensor devices 208 can include image capture devices for generating image data associated with fruit in one or more compartments. The one or more sensor devices 208 can include weight sensors for determining a weight/quantity of fruit in each compartment. The one or more sensor devices 208 can include temperature sensors for generating temperature data and/or humidity sensors (hygrometers) for detecting humidity levels inside each compartment. The one or more sensor devices 208 can optionally also include ethylene gas detectors for detecting presence of ethylene gas in each compartment and/or quantity or concentration of ethylene gas in each compartment.

A multi-use 210 ethylene gas cartridge 212 supplies ethylene gas 214 to an ethylene gas metering device 110. The multi-use 210 ethylene gas cartridge 212 in this example is a disposable cartridge which is replaced by the user when the supply of gas within the cartridge is empty. The ethylene gas cartridge 212 can be made of plastic, metal, a combination of plastic and metal, or any other suitable material. The ethylene gas cartridge 212 in this example is 0.5 inches in diameter. In other examples, the cartridge diameter varies from 0.25 to 2.0 inches. However, the examples are not limited to these measurements. The ethylene gas cartridge 212 can be a bottle, bag, cartridge, or any other type of container having any dimensions suitable for storing a quantity of ethylene gas.

The ethylene gas cartridge 212 stores a relatively small quantity of ethylene gas. In one example, the ethylene gas cartridge 212 stores a half-ounce of ethylene gas. In another example, the ethylene gas cartridge 212 stores 0.3 fluid ounces. In still another example, the ethylene gas cartridge 212 contains 0.5 fluid ounces. In yet another example, the ethylene gas cartridge 212 stores 1.0 fluid ounces. In other examples, the ethylene gas cartridge contains an amount of fluid within a range from 0.1 to 2.0 fluid ounces. The examples are not limited to these quantities. In other examples, the ethylene gas cartridge contains any quantity of ethylene gas suitable for the home appliance.

The ethylene gas cartridge 212 attaches to an aperture or connection device connecting the ethylene gas cartridge 212 to an ethylene gas metering device 110 associated with the fruit ripening device. Ethylene gas flows out of the cartridge via an opening/aperture or valve in the cartridge.

The ethylene gas metering device 110 meters ethylene gas into one or more compartments in the plurality of compartments 204 to accelerate ripening of fruit in the one or more compartments.

The ethylene gas metering device 110 in some examples provides ethylene gas 214 to each compartment in the plurality of compartments 204 via a set of ethylene gas supply lines 218. The set of ethylene gas supply lines 218 includes one or more supply lines, such as hoses or other conduits, for metering a selected quantity of ethylene gas into a selected compartment in the plurality of compartments 204.

The fruit ripening drawer 106 can optionally include a user interface device 120. The user interface device 120 is a device providing an input and/or output device for receiving user input and/or outputting data to the user. A user enters/selects a set of fruit ripening configurations for each compartment in the plurality of compartments via a set of configuration controls 222.

The set of configuration controls 222 is a set of one or more control devices for receiving parameters for controlling the per-compartment fruit ripening/variable fruit ripening within the fruit ripening drawer 106. The set of configuration controls 222 can be a touch screen controls, push button controls, a physical dial controller, a voice control system for receiving manual commands or any other controls for receiving configuration settings from a user.

The fruit ripening drawer 106 in some examples includes a control device 224. The control device 224 has at least one memory 228 and at least one processor 226 communicatively coupled to the memory 228. The control device 224 can implement a controller component, such as the controller component 134 in FIG. 1.

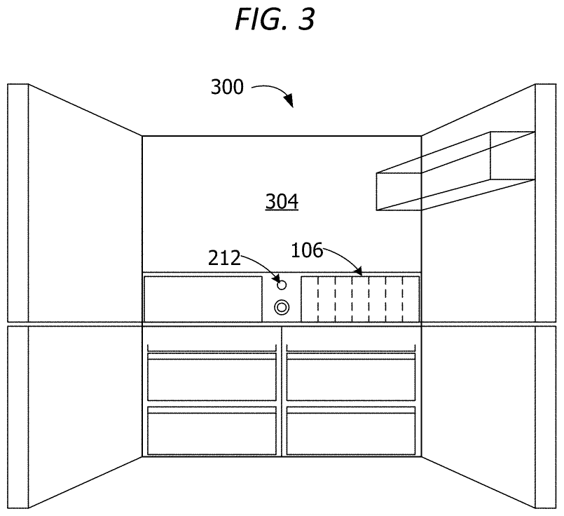

FIG. 3 is an exemplary block diagram illustrating a fruit ripening system 100 including a fruit ripening drawer 106 inside a refrigerator 304. The fruit ripening drawer 106 is incorporated into the refrigerator 304 or removably attaches to a portion of an interior of the refrigerator 304. The fruit ripening drawer 106 includes a removable ethylene gas cartridge 212. The ethylene gas cartridge 212 in this example is a multi-use ethylene gas cartridge. In other examples, the ethylene gas cartridge 212 is a single-use ethylene gas cartridge. The cartridge 306 inserts or attaches to a valve or other port on an ethylene gas metering device inside the fruit ripening drawer 106.

The fruit ripening drawer 106 can optionally include a water reservoir, pocket, channel, cartridge or compartment for storing water within the fruit ripening drawer 106. The water cartridge or other container connects to or inserts into the fruit ripening drawer 106. The system utilizes the water to adjust the humidity levels within each compartment. In some examples, a refill water notification is output to a user via a user interface device on the fruit ripening drawer 106 or via a notification transmitted to the fruit ripening application on a user device associated with the user, such as the user device 126 in FIG. 1. The user can replace the water cartridge/container with another disposable or re-fillable water cartridge.

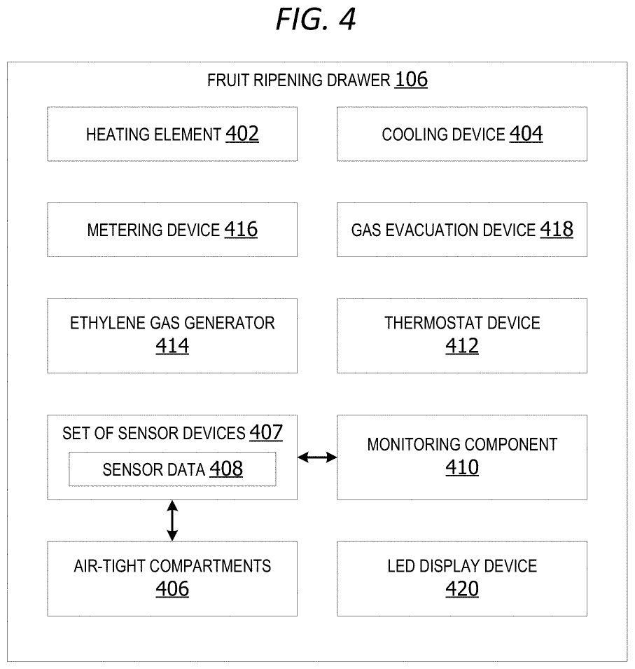

FIG. 4 is an exemplary block diagram illustrating a stand-alone fruit ripening drawer 106. The fruit ripening drawer 106 includes a heating element 402 and/or a cooling device 404 for controlling the temperature inside each compartment in the one or more air-tight compartments 406 within the fruit ripening drawer 106. The heating element can include a heating coil or other device for increasing temperature inside a compartment. The cooling device 404 in some non-limiting examples includes a condenser or other device for lowering temperature within the compartment.

A set of one or more sensor devices 407 associated with the air-tight compartments 406 generates sensor data 408 associated with conditions within the air-tight compartments 406. The set of sensor devices 407 can include one or more weight sensors, temperature sensors, pressure sensors, humidity sensors, ethylene gas sensors, image capture devices, or any other type of sensor devices. The image capture devices can include infrared sensors and/or cameras. The sensor data 408 can include, for example but without limitation, weight data, temperature data, humidity level data, pressure data, ethylene gas concentration data, image data, infrared data, camera images, etc.

A monitoring component 410 analyzes the sensor data 408 generated by the set of sensor devices 407 within the plurality of air-tight compartments 406 to determine the conditions/state within each compartment. The monitoring component 410 determines current temperature within each compartment, humidity levels within each compartment, weight of fruit within each compartment, appearance/color of fruit within each compartment, concentration of ethylene gas within each compartment and/or any other conditions within each compartment. If the temperature within a given compartment is greater than or less than a desired temperature for fruit ripening, a thermostat device 412 activates the heating element 402 and/or the cooling device 404 to adjust the temperature inside the one or more compartments.

In this example, an ethylene gas generator 414 supplies ethylene gas to a gas metering device 416. The device can also include a liquid ethyl alcohol cartridge connected to the ethylene gas generator 414. The ethylene gas generator 414 converts the liquid ethyl alcohol into ethylene gas for release into at least one compartment in the fruit ripening drawer 106. The ethylene gas generator can be a catalytic converter.

When the fruit in a given compartment has been exposed to ethylene gas for a sufficient amount of time, a gas evacuation device 418 removes the ethylene gas from the given compartment. The gas evacuation device 418 in some example pulls the ethylene gas out of the compartment via a fan or suction device. The evacuated ethylene gas can be stored in a cartridge, bag or other container. In other examples, the gas evacuation device 418 blows, pushes, pulls or otherwise evacuates the ethylene gas out of the fruit ripening drawer 106 via a vent or other opening that permits the ethylene gas to be expelled from at least one compartment.

A light emitting diode (LED) display device 420 is included in some examples. If the cartridge of compressed ethylene gas is empty or partially empty (level below a threshold), the LED display device 420 outputs a cartridge replacement notification to notify at least one user to replace a reusable ethylene gas cartridge replacement.

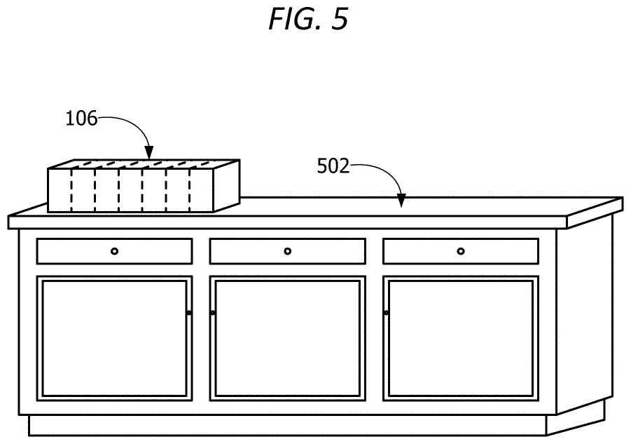

FIG. 5 is an exemplary block diagram illustrating a stand-alone fruit ripening drawer 106 on a counter-top 502. The fruit ripening drawer 106 includes two or more compartments for ripening fruit to a selected level of ripening at variable rates for consumption on two or more different days. Each compartment in this example is itself a well-insulated produce drawer capable of sliding open to permit placement of an item of produce into the compartment and/or removal of an item of produce from the compartment. In other examples, each compartment is a rectangular-shaped compartment having a hinged door along a top member of fruit ripening drawer 106 or along a side member of the fruit ripening drawer to permit the user to add an item of produce to a compartment or remove an item of produce from a compartment.

The stand-alone fruit ripening drawer 106 includes a temperature-control device, such as a heating element and/or a cooling device for controlling temperature within each compartment. The temperature control device controls/adjusts variable temperatures/conditions within each compartment. Thus, the temperature within a first compartment can be sixty-four degrees while the temperature in the second compartment is only fifty-eight degrees.

In this example, the heating and/or cooling device is incorporated within the fruit ripening drawer 106. In other examples, the fruit ripening drawer 106 is incorporated within or added into an internal portion of a refrigeration appliance which provides the heating and/or cooling to adjust temperature inside each compartment.

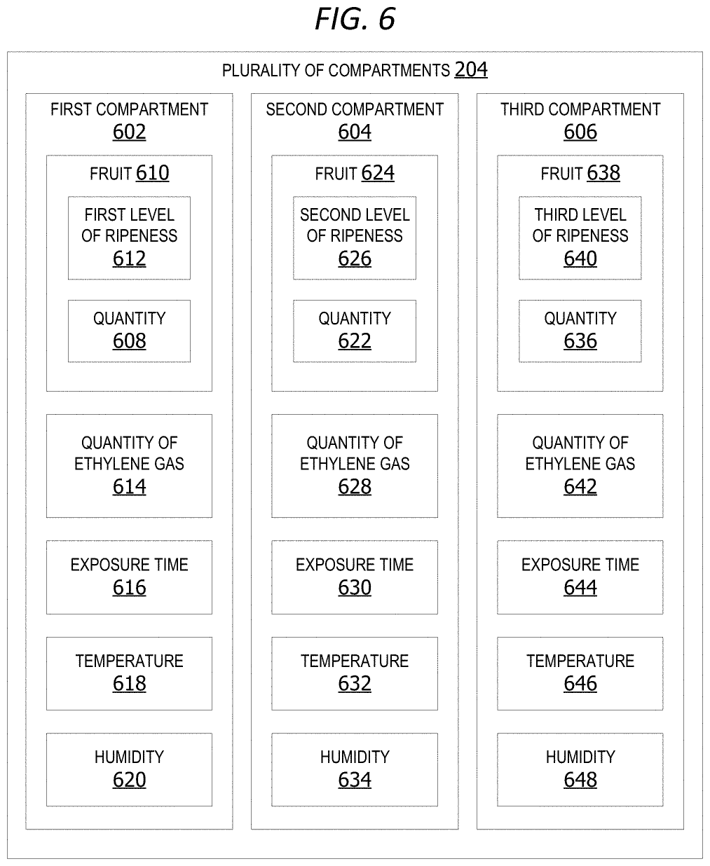

FIG. 6 is an exemplary block diagram illustrating a plurality of compartments 204 within a fruit ripening drawer. In this non-limiting example, the plurality of compartments 204 includes a first compartment 602, a second compartment 604 and a third compartment 606. In other examples, the plurality of compartments 204 includes two compartments, four compartments, five compartments, six compartments or any other number of compartments. In one non-limiting example, the plurality of compartments 204 includes seven compartments corresponding to each day within a week.

In this example, the first compartment 602 includes a first quantity 608 of fruit 610 being ripened to a first level of ripeness 612. A first quantity of ethylene gas 614 is released into the first compartment 602 for a first exposure time 616. The first compartment 602 is maintained at a first temperature 618 and a first humidity 620 to assist ripening of the fruit 610.

The second compartment 604 in this example includes a quantity 622 of unripe fruit 624 being ripened to a second level of ripeness 626. The second level of ripeness 626 in this example is a different level of ripeness than the first level of ripeness 612. In other examples, the first level of ripeness 612 and the second level of ripeness 626 are the same level of ripeness. A quantity of ethylene gas 628 is released into the second compartment 604 for an exposure time 630 at a temperature 632 and humidity 634 level calculated to ripen the fruit 624 to the selected level of ripeness 626 by a user-selected date of consumption.

The third compartment 606 in this example includes a quantity 636 of unripe fruit 638 being ripened to a third level of ripeness 640. The third level of ripeness 640 in this example is a different level of ripeness than the first level of ripeness 612 and the second level of ripeness 626. In other examples, the first level of ripeness 612, the second level of ripeness 626 and the third level of ripeness 640 are the same level of ripeness. A quantity of ethylene gas 642 is released into the third compartment 606 for an exposure time 644 at a temperature 646 and humidity 648 level calculated to ripen the fruit 638 to the selected level of ripeness 640 by a user-selected date of consumption.

In this example, each compartment within the fruit ripening device is an insulated, air-tight compartment capable of maintaining different temperatures/conditions within each compartment. In this manner, an unripe banana placed in the first compartment and another unripe banana placed inside the second compartment on the same starting day can be ready (fully ripened to the selected level of ripeness) on different days. The device utilizes/provides onboard refrigeration (vapor compression or Peltier), ventilation for releasing/evacuating the ethylene gas when the initial exposure is complete. The device in some non-limiting examples utilizes a manifold and metering valves or orifices to introduce ethylene gas into a given compartment and to evacuate the ethylene gas from the compartment.

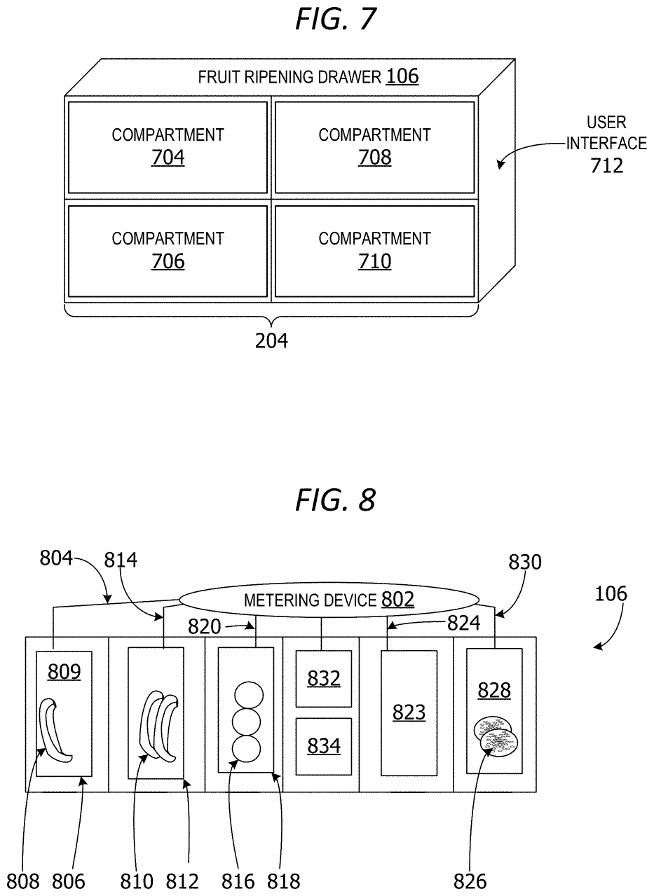

FIG. 7 is an exemplary block diagram illustrating a plurality of compartments 204 within a fruit ripening drawer 106. The plurality of compartments 204 in this example are arranged in a stacked manner. For example, but without limitation, compartment 704 is stacked on top of compartment 706 and compartment 708 is stacked on top of compartment 710. In other examples, the compartments are arranged linearly/horizontally such that no compartment is stacked on top of another compartment. In still other examples, all the compartments are stacked vertically, in a columnar format such that a first compartment is stacked on top of a second compartment which is stacked on top of a third compartment, and so forth.

A user interface 712 is provided which enables a user to input fruit ripening configurations. The fruit ripening configurations can include a date of consumption, a quantity of bananas and/or a user-selected level of ripeness. The user interface 712 can include a voice recognition system, a touch screen, a menu-driven interface, a command-line interface, a graphical user interface (GUI) and/or physical controls. Physical controls can include one or more toggles, push buttons, dials, switches, etc.

In some non-limiting examples, the plurality of compartments 204 in the fruit ripening drawer 106 are small single-banana-sized compartments. In other words, each compartment is sized to hold a single banana. Each compartment in the fruit ripening drawer 106 has a separate consumption date (ripening completion date) setting. The user can set each compartment to produce a single ripened banana every day to provide a banana a day. If the user wishes to ripen four or more bananas for the same date, the user can place a single banana in four or more compartments and set the fruit ripening configurations for those four or more compartments with the same consumption date.

In another example, the compartments is sized to hold two or three bananas. In these examples, a user sets the per-compartment configurations to provide two or three ripened bananas per day. This option can be provided for larger family sizes in which multiple members of a household wish to have one banana per-day.

FIG. 8 is an exemplary block diagram illustrating a plurality of compartments connected to a metering device 802 within a fruit ripening drawer 106. The metering device 802 supplies ethylene gas to ripen an item of fruit 808 within a first compartment 806 via an ethylene gas supply line 804 connecting the metering device 802 to the compartment 806. The ethylene gas supply line 804 can be implemented as a tube, pipe, channel, conduit, or any other delivery system for moving gas from a single ethylene gas supply source (ethylene gas cartridge or generator) to one or more compartments. The item of fruit 808 in the first compartment 806 is currently ready for consumption (ripened to user-selected level of ripeness) today (first day). The quantity of fruit 808 in this example is a single banana.

The metering device 802 supplies ethylene gas to ripen unripe fruit 810 within a second compartment 812 via an ethylene gas supply line 814 connecting the metering device 802 to the compartment 812. The unripe fruit 810 in the second compartment 812 is fruit which is pre-ripe (green) and not yet ready for consumption. The unripe fruit 810 in this example is scheduled to be ready for consumption (ripened to user-selected level of ripeness) on a second day in this example. The quantity of unripe fruit 810 in this example includes two bananas.

The metering device 802 supplies ethylene gas to ripen fruit 816 within a third compartment 818 via an ethylene gas supply line 820 connecting the metering device 802 to the compartment 818. The fruit 816 in the compartment 818 is scheduled to be ready for consumption (ripened to user-selected level of ripeness) on the second day in this example. The quantity of fruit 816 in this example includes three mangoes.

The metering device 802 supplies ethylene gas to ripen fruit within a fourth compartment 822 via an ethylene gas supply line 824 connecting the metering device 802 to the compartment 822. In this non-limiting example, the fourth compartment is empty. If the user enters fruit ripening configurations associated with the fourth compartment 822, the user device on the fruit ripening drawer 106 outputs a notification instructing the user to place the desired quantity of fruit inside the empty fourth compartment 822. The fruit ripening drawer 106 can determine the fourth compartment 822 is empty based on sensor data generated by sensor device(s) associated with the fourth compartment. For example, the sensor data can include image data showing the lack of contents, weight data indicating an absence of weight within the compartment, pressure data indicating a lack of pressure exerted by fruit in the compartment, etc.

The metering device 802 supplies ethylene gas to ripen fruit 826 within a fifth compartment 828 via an ethylene gas supply line 830 connecting the metering device 802 to the compartment 828. The fruit 826 is scheduled to be ready for consumption (ripened to user-selected level of ripeness) on a third day in this example. The quantity of fruit 826 in this example includes two avocadoes.

The fruit ripening drawer 106 also includes an ethylene gas source 823. In this non-limiting example, the ethylene gas source is an ethylene gas converter or an ethylene gas cartridge. The fruit ripening drawer 106 in this example also includes a thermostat device 834 for regulating internal temperature of the compartments. The thermostat device 834 can control temperature, humidity or temperature and humidity.

The fruit ripening drawer 106 in this example includes five fruit ripening compartments. In other examples, the fruit ripening drawer 106 includes two compartments, three compartments, four compartments, as well as six or more compartments.

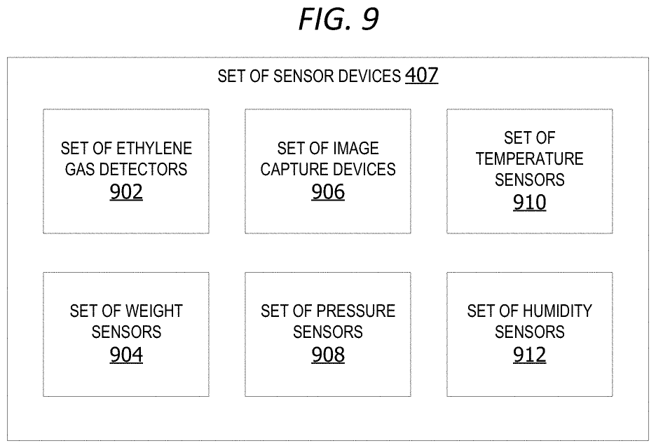

FIG. 9 is an exemplary block diagram illustrating a set of sensor devices 407 associated with compartments in a fruit ripening drawer. The set of sensor devices 407 can include, without limitation, a set of one or more ethylene gas detectors for detecting a presence/absence of ethylene gas and/or the concentration of ethylene gas within each compartment. The set of sensor devices 407 optionally includes a set of one or more weight sensors 904 for generating weight data associated with contents of each compartment and/or a set of one or more pressure sensors 908 for generating pressure data associated with fruit placed inside one or more compartments.

A set of one or more image capture devices 906 can be included. An image capture device can include an infrared sensor, a camera, or any other type of image capture device. Image data generated by the set of image capture devices 906 can be analyzed to determine whether a compartment is empty, identify a quantity of fruit within each compartment, identify a type of fruit within each compartment, identify a current level of ripeness of fruit within each compartment, etc.

A set of one or more temperature sensors 910 generates temperature data associated with a current temperature inside each compartment. A set of one or more humidity sensors 912 can be optionally provided to identify a level of humidity within each compartment. A humidity sensor in the set of humidity sensors 912 can be implemented as a hygrometer.

The set of sensor devices 407 can include other sensor devices not shown in FIG. 9. For example, the set of sensor devices 407 can include photosensors, spectrometers, or other sensor devices.

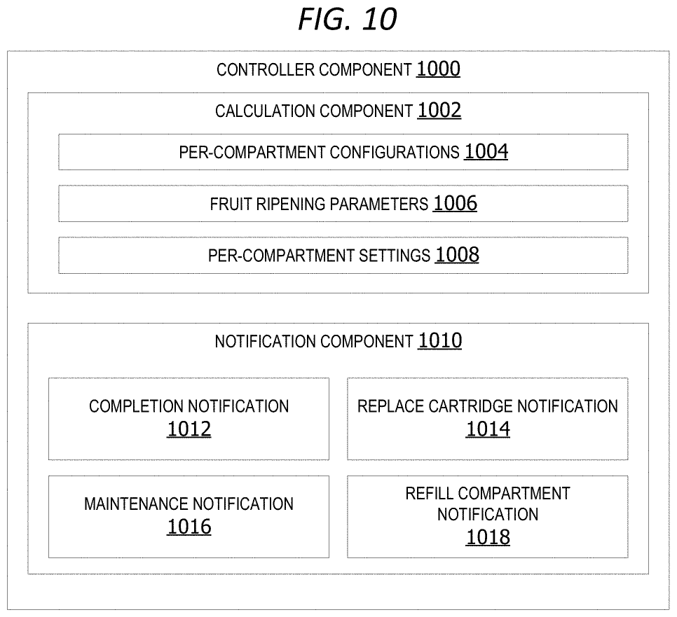

FIG. 10 is an exemplary block diagram illustrating a controller component 1000. A calculation component 1002 analyzes per-compartment fruit ripening configurations 1004 selected by a user using a set of fruit ripening parameters 1006 to calculate per-compartment settings 1008. The fruit ripening parameters 1006 include parameters for setting temperature and humidity required to ripen fruit within the amount of time available prior to the user-selected date of consumption, such as, but not limited to, the parameters 136 in FIG. 1. The per-compartment settings 1008 specify the quantity of ethylene gas, duration of gas exposure, temperature and/or humidity for each compartment to achieve the first level of ripeness of the unripe fruit by the first consumption date. The fruit ripening parameters 1006 are based on the type of unripe fruit (bananas, mangoes, etc.), quantity of the unripe fruit in each compartment, ripening time, temperature, humidity, volume of compartment, user-selected ripeness level and the consumption date for the fruit in each compartment. The ripening time is the amount of time between initial exposure of the produce to ethylene gas and the selected consumption date.

A notification component 1010 outputs notification to users via a user interface device on the fruit ripening drawer and/or transmitting the notification to a user device. In some examples, the notification component 1010 outputs a completion notification 1012 indicating the fruit in a selected compartment has reached the user-selected level of ripeness. The notification component 1010 can output a replace cartridge notification 1014 if sensor data indicators the ethylene cartridge is empty. In other examples, the notification component 1010 outputs the replace cartridge notification 1014 if the amount of gas remaining in the cartridge is less than or equal to a threshold minimum amount of ethylene gas.

The notification component 1010 in other examples output a maintenance notification 1016 if sensor data indicates a mechanical failure or maintenance requirements associated with the fruit ripening drawer. For example, the maintenance notification 1016 can be output if sensor data indicates an absence of ethylene gas following activation of the metering device to release a quantity of ethylene gas into the compartment.

The notification component 1010 in other examples outputs a refill compartment notification 1018 if sensor data indicates a compartment is empty. The refill compartment notification 1018 identifies the empty compartment and recommends the user refills the compartment with unripe fruit.

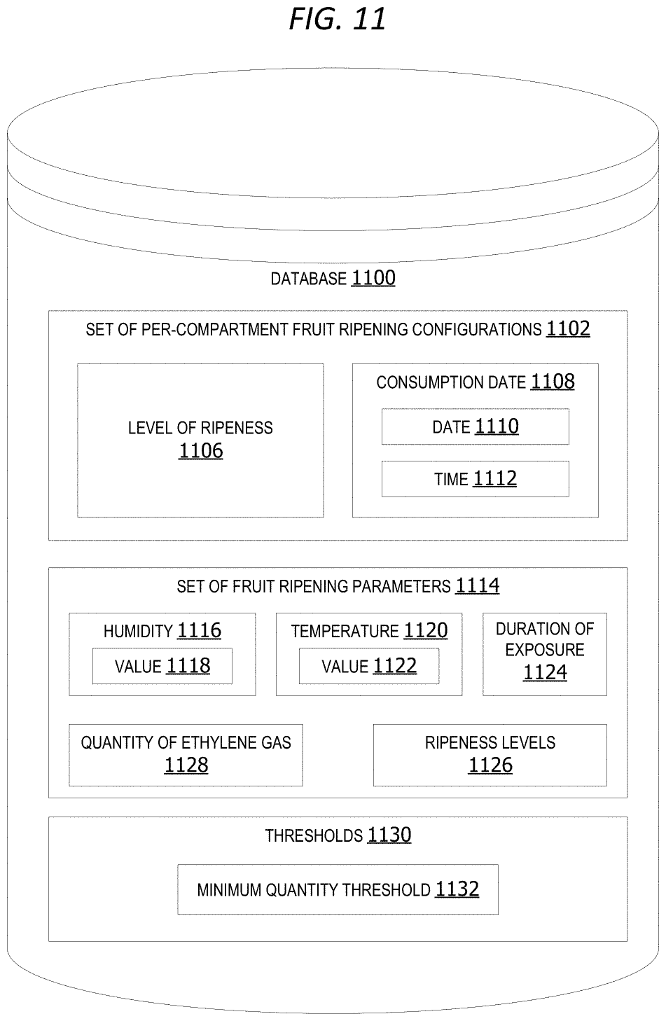

FIG. 11 is an exemplary block diagram illustrating a database 1100 storing fruit ripening data. A set of per-compartment fruit ripening configurations 1102 in this example includes a level of ripeness 1106 selected by a user and a consumption date 1108 for the fruit in a selected compartment. The consumption date 1108 can include a date 1110 and/or a time 1112 for consumption of the fruit.

A set of fruit ripening parameters 1114 includes parameters/variables for accelerating or delaying fruit ripening. The parameters include, without limitation, humidity 1116 value 1118 (level of humidity), temperature 1120 value 1122, duration of exposure 1124, ripeness levels 1126 and/or quantity of ethylene gas 1128.

In some examples, the system monitors duration of exposure 1124 (time ethylene gas is present within a compartment) by starting a clock when ethylene gas is first released into the compartment via the aperture. In other examples, the system generates a time stamp when an aperture is opened/ethylene gas flow into the compartment begins. The time stamp records the start date and/or time when ethylene gas is released into the compartment. The time stamp is compared to a current time to determine duration of gas exposure.

The database 1100 can include thresholds 1130. The thresholds 1130 can include a minimum (MIN) quantity threshold 1132. The minimum quantity threshold 1132 is a minimum level of ethylene gas within a replaceable ethylene gas cartridge.

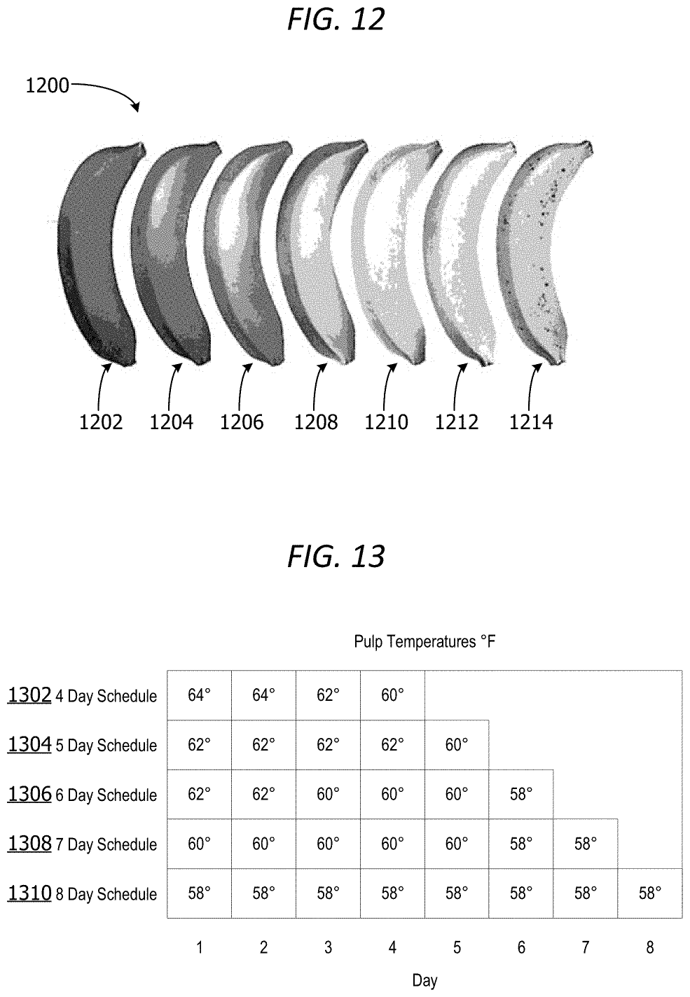

FIG. 12 is an exemplary block diagram illustrating levels 1200 of ripeness for bananas. The levels of ripeness in these non-limiting examples includes completely green 1202, green with a trace of green 1204, half green/half yellow 1206, more yellow than green 1208, mostly yellow with green tips 1210, all yellow 1212 and yellow flecked with brown 1214. The levels of ripeness shown in FIG. 12 are non-limiting examples of ripeness levels. In other examples, the levels of ripeness can include additional levels of ripeness not shown in FIG. 12. Likewise, the available levels of ripeness for the fruit ripening rack can include fewer levels of ripeness than shown in FIG. 12.

FIG. 13 is an exemplary block diagram illustrating a set of temperature settings 1300 for ripening fruit. In some examples, the rate of ripening of produce within a selected compartment is controlled via ripening time and temperature. The ripening time is the amount of time between initial exposure to ethylene gas and the user-selected data of consumption when the produce is scheduled for removal from the device and/or consumption. The temperature is the temperature and/or humidity level inside the compartment during the ripening time. For example, if the length of time between the initial exposure to the ethylene gas is three days, the temperature within the compartment is higher than if the ripening time is eight days. In other words, the longer the ripening time, the lower the temperature necessary to ripen produce to the selected ripeness level.

If the date of consumption is four days 1302 away, in this example, the temperature within the compartment on the first day is set to sixty-four degrees and lowered to sixty degrees on the fourth day (consumption date) when ripening to the selected level is complete. If the date for consumption is five days 1304, the temperature is maintained at sixty-two degrees until the fifth day when the temperature is lowered to sixty degrees.

In another example, a six-day schedule 1306 begins at a lower sixty-two degrees on the first day and gradually decreases to fifty-eight degrees on the sixth day. For a seven-day schedule 1308, the temperature is set to sixty degrees on the first day through the fifth day and then lowered to fifty-eight degrees for the sixth and seventh day. If the date of consumption is in eight days 1310, the temperature is maintained at fifty-eight degrees for the entire eight days of fruit ripening.

The examples are not limited to the ripening times and temperatures shown in FIG. 13. In other examples, produce is ripened at other temperatures within different ripening time-periods not shown in FIG. 13. For example, some types of produce can be ripened within a twenty-four or forty-eight-hour ripening time at a higher temperature, such as sixty-eight degrees or seventy-two degrees depending upon humidity levels within the compartments, pressure level within the compartments and/or any previous exposure to ethylene gas which alters the effect of temperature on ripening time.

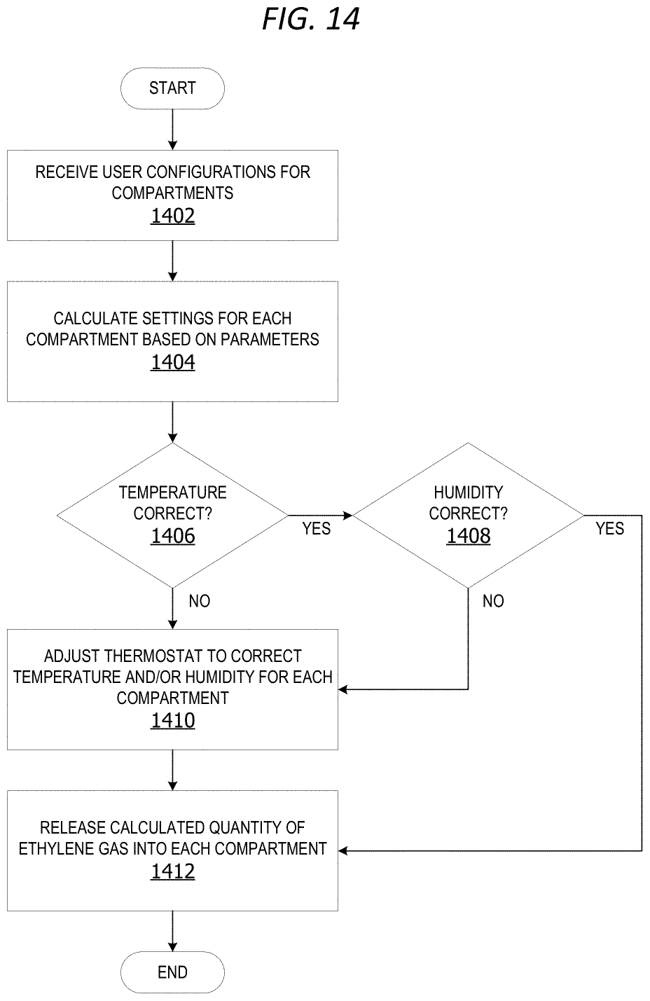

FIG. 14 is an exemplary flow chart illustrating operation of the computing device to customize settings within a plurality of compartments for ripening fruit at variable rates. The process shown in FIG. 14 can be performed by a controller component, executing on a processor within a fruit ripening device, such as the fruit ripening device 102 or the user device 126 in FIG. 1.

The process begins by receiving user configurations for compartments at 1402. The controller component calculates settings for each compartment based on parameters at 1404. The controller component determines if temperature within the compartment is correct at 1406. If yes, the controller component determines if the humidity within the compartment is correct at 1408. If the humidity is not correct at 1408 or the temperature is not correct at 1406, the controller component adjusts a thermostat to correct temperature and/or humidity for each compartment at 1410. The controller component releases a calculated quantity of ethylene gas into each compartment at 1412. The process terminates thereafter.

While the operations illustrated in FIG. 14 are performed by a fruit ripening device, aspects of the disclosure contemplate performance of the operations by other entities. For example, a cloud service can perform one or more of the operations.

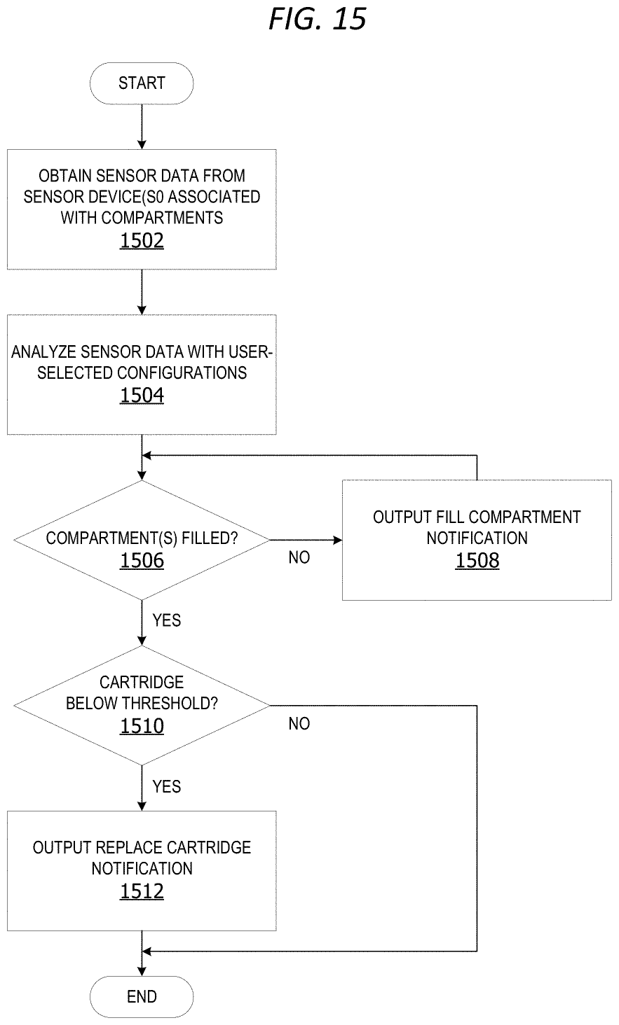

FIG. 15 is an exemplary flow chart illustrating operation of the computing device to monitor conditions within fruit ripening compartments and output maintenance notifications to a user based on detected conditions. The process shown in FIG. 15 can be performed by a controller component, executing on a processor within a fruit ripening device, such as the fruit ripening device 102 or the user device 126 in FIG. 1.

The process begins by obtaining sensor data from sensor device(s) associated with compartments at 1502. The controller component analyzes sensor data with user-selected configurations at 1504. The controller component determines if the compartments are filled at 1506. If no, the controller component outputs a fill compartment notification at 1508. When the compartment is filled, the controller component determines if the ethylene gas cartridge is below a threshold level at 1510. The controller component outputs a replace cartridge notification at 1512. The process terminates thereafter.

While the operations illustrated in FIG. 15 are performed by a fruit ripening device, aspects of the disclosure contemplate performance of the operations by other entities. For example, a cloud service can perform one or more of the operations.

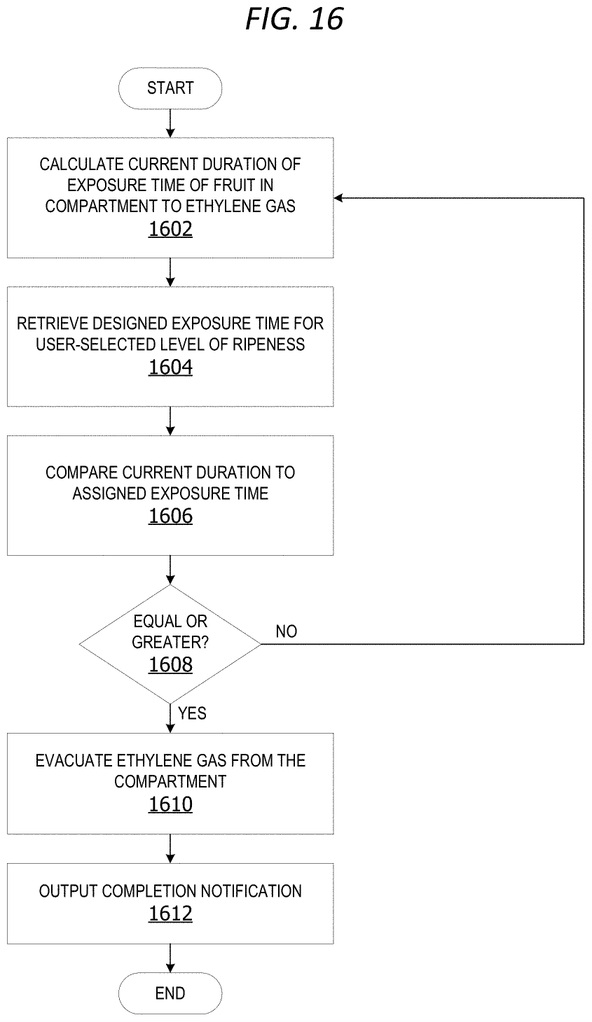

FIG. 16 is an exemplary flow chart illustrating operation of the computing device to increase or decrease ethylene gas content within each compartment to accelerate or delay fruit ripening within each compartment. The process shown in FIG. 16 can be performed by a controller component, executing on a processor within a fruit ripening device, such as the fruit ripening device 102 or the user device 126 in FIG. 1.

The process begins by calculating current duration of exposure time of fruit in compartment to ethylene gas at 1602. The controller component retrieves exposure time for user-selected level of ripeness at 1604. The controller component compares the current duration to the assigned exposure time at 1606. The controller component determines if the current duration is greater than or equal to assigned exposure time at 1606. If yes, the controller component evacuates ethylene gas from the compartment at 1610. The controller component outputs a completion notification at 1612. The process terminates thereafter.

While the operations illustrated in FIG. 16 are performed by a fruit ripening device, aspects of the disclosure contemplate performance of the operations by other entities. For example, a cloud service can perform one or more of the operations.

### Additional Examples

In some examples, a system and device for ripening bananas at home post-retail. The appliance can be incorporated into or otherwise added into a refrigerator appliance. When attached/added into a refrigerator or other appliance, the ripening date (date of consumption) can be set within a user interface associated with a smart refrigerator system. The refrigeration system controls the temperature, moisture and other conditions within the fruit ripening device compartments.

In other examples, the appliance is implemented as a stand-alone counter-top device for ripening fruit. In these examples, the ripening date is set within a user interface device on the fruit ripening appliance or via an application on a user device.

The home appliance in some examples includes a chamber or multiple chambers for storing un-ripened or partially ripened fruit. The device includes controls for setting/configuring a preferred date for completion and a degree of ripeness. For example, a user provides input indicating a 100% degree of ripeness (yellow banana with no green or brown) ready to eat in two days. A controller component calculates temperature and/or humidity necessary to accelerate ripening to the 100% degree of ripeness within the user-selected two days of ripening time. The calculations are made based on a set of variables influencing rate of ripening of produce. The variables include, without limitation, volume of the compartment/drawer, temperature, ripening time, humidity, type of produce, selected level of ripeness, concentration of ethylene gas, quantity of produce, date for consumption, etc.

The selection can be made via electrical or mechanical means. The system allows the ethylene gas to flow from a replaceable storage cartridge through an aperture at the time and flow rate as dictated by the user input.

In an example scenario, the home appliance moves the point of produce exposure to ethylene gas from pre-retail to post-retail. The entire produce supply chain is in a pre-ripe/pre-exposed state until ripening is initiated by the user via the home appliance. In other words, the consumer initiates ripening of produce in a decentralized (customized) state. The consumer dictates the quantity of produce ripened and the timing of ripe produce via settings/per-compartment configurations selected by the user.

The home fruit ripening drawer decentralizes produce ripening via metered ethylene gas exposure from a replaceable ethylene gas cartridge to selected compartments within the device. When the ethylene gas cartridge is empty or below a threshold minimum level, the system outputs/emits an alert or alarm notifying the user to replace the cartridge.

In one non-limiting example, the controller component automatically re-orders a replacement ethylene gas cartridge when sensor data indicates the ethylene gas cartridge is empty or almost empty (below a minimum level). Replacement cartridges can be ordered automatically via a network connection. In other examples, a fruit ripening application running on a user device, such as a smart phone, automatically orders a replacement cartridge from a supplier when a replace cartridge notification is received from the controller component.

The device includes two or more compartments for customized produce ripening. Each compartment can be composed of metal, plastic, rubber or any other suitable material. The metering device controls flow rate of ethylene gas through an aperture in each compartment and time of exposure to ethylene gas within each compartment. Each compartment is self-contained/air-tight to prevent ethylene gas from leaking out of one compartment into another compartment.

The device in some examples is set with consumer preferred dates for consumption and ripeness preferences. The user-selected per-compartment fruit ripening configurations dictate the time and flow rate of ethylene gas into each compartment. For example, the user can select ripening a single banana for consumption each day with a ripeness level of 100% yellow with no green or brown speckling. The user can set per-chamber ripening preferences (per-compartment configurations) via electronic means (application/user interface) or mechanical means (buttons/dials).

The device in some examples includes pushbutton settings enabling a user to select ripening rate/consumption date and ripening level. The device exposes unripe (unexposed produce) or pre-exposed produce to ethylene gas and/or adjusts temperature and humidity levels within the compartments to accelerate/adjust ripening rate of produce.

The system analyzes sensor data in other examples to determine the current state/level of ripeness of produce. In one example, the controller component utilizes computer vision via image data received from one or more image capture devices to determine the current state of produce in one or more compartments. In this example, the interior of a compartment is white. A photosensor determines the average current color value of produce inside the compartment. In other words, the system analyzes image data including an image of at least a portion of fruit inside the compartment to determine the current state color. The user provides input to determine the desired end state color associated with the user-selected level of ripeness to determine the desired ready-date (consumption date), a gas rate and calculated follow-up time/temperature. The system uses this rate to dilate an orifice to accomplish the calculated ethylene gas flow rate into a selected compartment, as well as maintain and adjust the atmospheric conditions within an interior of the selected compartment over time to achieve optimum ripe condition at the user-selected (user input) consumption date/time.

Alternatively, or in addition to the other examples described herein, examples include any combination of the following:
a third set of user-selected configurations in the set of per-compartment fruit ripening configurations further comprising a third level of ripeness for fruit in a third compartment in the plurality of compartments and a third consumption date identifying a date at which the fruit in the third compartment is scheduled to achieve the third level of ripeness, wherein the third consumption date is a different date than the first consumption date and the second consumption date;
the controller component, implemented on the at least one processor, activates the ethylene gas metering device to release a third quantity of ethylene gas into the third compartment at a third temperature calculated to accelerate ripening of the fruit in the third compartment to achieve the third level of ripeness on the third consumption date;
wherein the plurality of compartments in the fruit ripening drawer includes seven air-tight compartments, each compartment in the plurality of compartments stores fruit for consumption on each day of a week;
a calculation component, implemented on the at least one processor, analyzes the set of per-compartment fruit ripening configurations selected by a user using a set of fruit ripening parameters for a user-selected type of unripe fruit and quantity of the unripe fruit in the first selected compartment to generate the first quantity of ethylene gas, the first temperature and a first humidity value to achieve the first level of ripeness of the unripe fruit by the first consumption date;
wherein the fruit ripening drawer attaches to an interior portion of a refrigerator appliance;
wherein the fruit ripening drawer is a counter-top stand-alone appliance including a cooling device and a heating element for regulating an internal temperature of each compartment in the plurality of compartments;
a communications interface device, implemented on the at least one processor, receives the set of per-compartment fruit ripening configurations from a user device via a network;
the controller component, implemented on the at least one processor, receives an updated set of per-compartment fruit ripening configurations including an updated consumption date for at least one compartment;
the controller component activates the ethylene gas metering device or a gas evacuation device to alter a quantity of ethylene gas in at least one compartment in the plurality of compartments to accelerate ripening of the fruit in the at least one compartment or delay ripening of the fruit in the at least one compartment to achieve a selected level of ripeness on the updated consumption date;
a notification component, implemented on the at least one processor, outputs a replace cartridge notification to at least one user on condition a quantity of ethylene gas remaining in the cartridge is below a minimum quantity threshold;
wherein the fruit ripening drawer comprises a plurality of air-tight compartments;
releasing configurable quantities of ethylene gas into each compartment in the plurality of compartments calculated to stagger ripening of fruit in each compartment such that fruit in one compartment achieves a user-selected level of ripeness on each day of a week;
analyzing, by a monitoring component, sensor data generated by a set of sensors within the plurality of air-tight compartments;
generating, by a notification component, a completion notification indicating the fruit in the first compartment has reached the first level of ripeness on condition a result of the analysis of the sensor data confirms the level of ripeness has been achieved;
outputting, by a notification component, a replace cartridge notification to at least one user on condition a quantity of ethylene gas remaining in the cartridge is below a minimum quantity threshold;
outputting, by a notification component, a maintenance notification to at least one user on condition sensor data generated by a set of sensors located within at least one compartment of the fruit ripening drawer indicates an absence of ethylene gas following activation of the metering device to release a quantity of ethylene gas into the compartment;
outputting, by a notification component, a refill compartment notification to at least one user to refill a selected compartment with unripe fruit on condition the controller component receives a set of user-selected configurations for ripening fruit in the selected compartment and sensor data generated by at least one sensor device in the selected compartment indicates the selected compartment is empty;
receiving, by the controller component, an updated set of per-compartment fruit ripening configurations including an updated consumption date for at least one compartment;
activating, by the controller component, the ethylene gas metering device or a gas evacuation device to alter a quantity of ethylene gas in the at least one compartment to accelerate ripening of the fruit in the at least one compartment or delay ripening of the fruit in the at least one compartment to achieve a selected level of ripeness on the updated consumption date;
a light emitting diode (LED) display device that outputs a cartridge replacement notification to notify at least one user to replace a reusable ethylene gas cartridge replacement;
a set of sensor devices associated with the set of compartments, the set of sensor devices comprising at least one of a set of ethylene gas detectors, a set of image capture devices, a set of weight sensors, a set of pressure sensors or a set of temperature sensors; and
a user interface device comprising a set of configuration controls, the user interface device receives a set of per-compartment fruit ripening configurations for customizing ripening of fruit in each compartment in the set of compartments via the set of configuration controls.

At least a portion of the functionality of the various elements in FIG. 1, FIG. 2, FIG. 3, FIG. 4, FIG. 5, FIG. 6, FIG. 7, FIG. 8, FIG. 9, FIG. 10 and FIG. 11 can be performed by other elements in FIG. 1, FIG. 2, FIG. 3, FIG. 4, FIG. 5, FIG. 6, FIG. 7, FIG. 8, FIG. 9, FIG. 10 and FIG. 11, or an entity (e.g., processor 116, web service, server, application program, computing device, etc.) not shown in FIG. 1, FIG. 2, FIG. 3, FIG. 4, FIG. 5, FIG. 6, FIG. 7, FIG. 8, FIG. 9, FIG. 10 and FIG. 11.

In some examples, the operations illustrated in FIG. 14, FIG. 15 and FIG. 16 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH®” as used herein refers, in some examples, to a wireless technology standard for exchanging data over short distances using short wavelength radio transmission. The term “cellular” as used herein refers, in some examples, to a wireless communication system using short-range radio stations that, when joined together, enable the transmission of data over a wide geographic area. The term “NFC” as used herein refers, in some examples, to a short-range high frequency wireless communication technology for the exchange of data over short distances.

### Exemplary Operating Environment

Exemplary computer-readable media include flash memory drives, digital versatile discs (DVDs), compact discs (CDs), floppy disks, and tape cassettes. By way of example and not limitation, computer-readable media comprise computer storage media and communication media. Computer storage media include volatile and nonvolatile, removable and non-removable media implemented in any method or technology for storage of information such as computer-readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer-readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other general purpose or special purpose computing system environments, configurations, or devices.

Examples of well-known computing systems, environments, and/or configurations that can be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices can accept input from the user in any way, including from input devices such as a keyboard or pointing device, via gesture input, proximity input (such as by hovering), and/or via voice input.

Examples of the disclosure can be described in the general context of computer-executable instructions, such as program modules, executed by one or more computers or other devices in software, firmware, hardware, or a combination thereof. The computer-executable instructions can be organized into one or more computer-executable components or modules. Generally, program modules include, but are not limited to, routines, programs, objects, components, and data structures that perform tasks or implement abstract data types. Aspects of the disclosure can be implemented with any number and organization of such components or modules. For example, aspects of the disclosure are not limited to the specific computer-executable instructions or the specific components or modules illustrated in the figures and described herein. Other examples of the disclosure can include different computer-executable instructions or components having more functionality or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for customized fruit ripening via a home appliance. For example, the elements illustrated in FIG. 1, FIG. 2, FIG. 3, FIG. 4, FIG. 5, FIG. 6, FIG. 7, FIG. 8, FIG. 9, FIG. 10 and FIG. 11, such as when encoded to perform the operations illustrated in FIG. 14, FIG. 15 and FIG. 16, constitute exemplary means for receiving per-compartment fruit ripening configurations for each compartment in a plurality of compartments associated with a fruit ripening drawer; exemplary means for calculating a quantity of ethylene gas, a temperature and a humidity value to ripen fruit in each compartment to a user-selected level of ripeness on a user-selected consumption date; exemplary means for setting a temperature and humidity within each compartment to the calculated temperature and humidity; exemplary means for activating an ethylene gas metering device to release the calculated quantity of ethylene gas into each compartment to achieve the selected level of ripeness of fruit in each compartment on the user-selected consumption date for each compartment.

In an exemplary embodiment, one or more of the exemplary embodiments include one or more localized IoT devices and controllers. As a result, in an exemplary embodiment, the localized IoT devices and controllers can perform most, if not all, of the computational load and associated monitoring and then later asynchronous uploading of summary data can be performed by a designated one of the IoT devices to a remote server. In this manner, the computational effort of the overall system can be reduced significantly. For example, whenever a localized monitoring allows remote transmission, secondary utilization of controllers keeps securing data for other IoT devices and permits periodic asynchronous uploading of the summary data to the remote server. In addition, in an exemplary embodiment, the periodic asynchronous uploading of summary data can include a key kernel index summary of the data as created under nominal conditions. In an exemplary embodiment, the kernel encodes relatively recently acquired intermittent data (“KRI”). As a result, in an exemplary embodiment, KRI includes a continuously utilized near term source of data, but KRI can be discarded depending upon the degree to which such KRI has any value based on local processing and evaluation of such KRI. In an exemplary embodiment, KRI may not even be utilized in any form if it is determined that KRI is transient and can be considered as signal noise. Furthermore, in an exemplary embodiment, the kernel rejects generic data (“KRG”) by filtering incoming raw data using a stochastic filter that provides a predictive model of one or more future states of the system and can thereby filter out data that is not consistent with the modeled future states which can, for example, reflect generic background data. In an exemplary embodiment, KRG incrementally sequences all future undefined cached kernels of data to filter out data that can reflect generic background data. In an exemplary embodiment, KRG incrementally sequences all future undefined cached kernels having encoded asynchronous data to filter out data that can reflect generic background data.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing an operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there can be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for location-based fruit ripening, the system comprising:
a fruit ripening drawer comprising a plurality of compartments for storing at least one item of unripe fruit, the plurality of compartments comprising a first compartment and a second compartment;
a set of ethylene gas supply lines connecting an ethylene gas metering device to the plurality of compartments, the ethylene gas metering device comprising an ethylene gas cartridge;
a data storage device stores a set of per-compartment fruit ripening configurations for customizing ripening of fruit in at least one compartment in the plurality of compartments, the set of per-compartment fruit ripening configurations comprising:
a first level of ripeness for a first quantity of unripe fruit in the first compartment;
a first consumption date associated with the first compartment;
a second level of ripeness for a second quantity of unripe fruit in the second compartment; and
a second consumption date associated with the second compartment;
a control device comprising a memory and at least one processor communicatively coupled to the memory; and
a controller component, implemented on the at least one processor, activates the gas metering device to release a first quantity of ethylene gas into the first compartment at a first temperature to complete ripening of the first quantity of unripe fruit in the first compartment to the first level of ripeness on the first consumption date and release a second quantity of ethylene gas into the second compartment at a second temperature to complete ripening of the second quantity of unripe fruit in the second compartment to the second level of ripeness on the second consumption date.

2. The system of claim 1, the set of per-compartment fruit ripening configurations further comprising:
a third level of ripeness for fruit in a third compartment in the plurality of compartments and a third consumption date identifying a date at which the fruit in the third compartment is scheduled to achieve the third level of ripeness, wherein the third consumption date is a different date than the first consumption date and the second consumption date; and
the controller component, implemented on the at least one processor, activates the ethylene gas metering device to release a third quantity of ethylene gas into the third compartment at a third temperature calculated to accelerate ripening of the fruit in the third compartment to achieve the third level of ripeness on the third consumption date.

3. The system of claim 1, wherein the plurality of compartments in the fruit ripening drawer includes seven air-tight compartments, each compartment in the plurality of compartments configured to contain fruit for consumption on each day of a week.

4. The system of claim 1, further comprising:
a calculation component, implemented on the at least one processor, analyzes the set of per-compartment fruit ripening configurations selected by a user using a set of fruit ripening parameters for a user-selected type of unripe fruit and the first quantity of the unripe fruit in the first selected compartment to generate the first quantity of ethylene gas, the first temperature and a first humidity value to achieve the first level of ripeness by the first consumption date.

5. The system of claim 1, wherein the fruit ripening drawer attaches to an interior portion of a refrigerator appliance.

6. The system of claim 1, wherein the fruit ripening drawer is a counter-top stand-alone appliance including a cooling device and a heating element for regulating an internal temperature of each compartment in the plurality of compartments.

7. The system of claim 1, further comprising:
a communications interface device, implemented on the at least one processor, receives the set of per-compartment fruit ripening configurations from a user device via a network.

8. The system of claim 1, further comprising:
the controller component, implemented on the at least one processor, receives an updated set of per-compartment fruit ripening configurations including an updated consumption date for the at least one compartment; and
the controller component activates the ethylene gas metering device or a gas evacuation device to alter a quantity of ethylene gas in the at least one compartment in the plurality of compartments to accelerate ripening of the fruit in the at least one compartment or delay ripening of the fruit in the at least one compartment to achieve a selected level of ripeness on the updated consumption date.

9. The system of claim 1, further comprising:
a notification component, implemented on the at least one processor, outputs a replace cartridge notification to at least one user on condition a quantity of ethylene gas remaining in the cartridge is below a minimum quantity threshold.

10. A computer-implemented method for customized fruit ripening in accordance with user-selected parameters, the computer-implemented method comprising:
receiving, via a user interface device, a set of per-compartment fruit ripening configurations for each compartment in a plurality of compartments associated with a fruit ripening drawer, the set of per-compartment fruit ripening configurations comprising a first set of user-selected configurations for a first compartment and a second set of user-selected configurations for a second compartment, the first set of user-selected configurations comprising a first level of ripeness and a first consumption date identifying a date at which unripe fruit in the first compartment is scheduled to achieve the first level of ripeness, the unripe fruit is fruit previously unexposed to ethylene gas, the second set of user-selected configurations comprising a second level of ripeness and a second consumption date at which the unripe fruit in the second compartment is scheduled to achieve the second level of ripeness;
calculating, by a calculation component, a first quantity of ethylene gas, a first temperature and a first humidity value to ripen fruit in the first compartment to the first level of ripeness on the first consumption date;
calculating, by the calculation component, a second quantity of ethylene gas, a second temperature and a second humidity value to ripen fruit in the second compartment to the second level of ripeness on the second consumption date;
setting, by a thermostat device, a temperature and humidity level within the first compartment to the first temperature and the first humidity;
setting, by the thermostat device, a temperature and humidity level within the second compartment to the second temperature and the second humidity; and
activating, by a controller component, an ethylene gas metering device to release the first quantity of ethylene gas into the first compartment to achieve the first level of ripeness of fruit in the first compartment on the first consumption date and the second quantity of ethylene gas into the second compartment to achieve the second level of ripeness of the fruit in the second compartment on the second consumption date.

11. The computer-implemented method of claim 10, wherein the fruit ripening drawer comprises a plurality of air-tight compartments and further comprising:
releasing configurable quantities of ethylene gas into each compartment in the plurality of compartments calculated to stagger ripening of fruit in each compartment such that fruit in one compartment achieves a user-selected level of ripeness on each day of a week.

12. The computer-implemented method of claim 10, further comprising:
analyzing, by a monitoring component, sensor data generated by a set of sensors within the plurality of air-tight compartments; and
generating, by a notification component, a completion notification indicating the fruit in the first compartment has reached the first level of ripeness on condition a result of the analysis of the sensor data confirms the first level of ripeness has been achieved.

13. The computer-implemented method of claim 10, further comprising:
outputting, by a notification component, a replace cartridge notification to at least one user on condition a quantity of ethylene gas remaining in the cartridge is below a minimum quantity threshold.

14. The computer-implemented method of claim 10, further comprising:
outputting, by a notification component, a maintenance notification to at least one user on condition sensor data generated by a set of sensors located within at least one compartment of the fruit ripening drawer indicates an absence of ethylene gas following activation of the metering device to release a quantity of ethylene gas into the compartment.

15. The computer-implemented method of claim 10, further comprising:
outputting, by a notification component, a refill compartment notification to at least one user to refill a selected compartment with at least one item of unripe fruit on condition the controller component receives a set of user-selected configurations for ripening fruit in the selected compartment and sensor data generated by at least one sensor device in the selected compartment indicates the selected compartment is empty.

16. The computer-implemented method of claim 10, further comprising:
receiving, by the controller component, an updated set of per-compartment fruit ripening configurations including an updated consumption date for at least one compartment; and
activating, by the controller component, the ethylene gas metering device or a gas evacuation device to alter a quantity of ethylene gas in the at least one compartment to accelerate ripening of the fruit in the at least one compartment or delay ripening of the fruit in the at least one compartment to achieve a selected level of ripeness on the updated consumption date.

17. A configurable fruit ripening device, the device comprising:
a plurality of compartments for storing unripe fruit, the unripe fruit comprising fruit previously unexposed to ethylene gas, the plurality of compartments comprising a first compartment and a second compartment;
a set of ethylene gas supply lines connecting an ethylene gas metering device to a set of compartments;
a control device comprising a memory and at least one processor communicatively coupled to the memory;
a controller component, implemented on the at least one processor, activates the ethylene gas metering device to release a first quantity of ethylene gas into the first compartment for a first exposure time to accelerate ripening of fruit in the first compartment to achieve a first user-selected level of ripeness of a first quantity of fruit on a first day; and
the controller component, implemented on the at least one processor, activates the ethylene gas metering device to release a second quantity of ethylene gas into the second compartment for a second exposure time to accelerate ripening of a second quantity of fruit in the second compartment to achieve a second user-selected level of ripeness on a second day.

18. The configurable fruit ripening device of claim 17, wherein the ethylene gas cartridge is a reusable ethylene gas cartridge and further comprising:
a light emitting diode (LED) display device that outputs a cartridge replacement notification to notify at least one user to replace a reusable ethylene gas cartridge replacement.

19. The configurable fruit ripening device of claim 17, further comprising:
a set of sensor devices associated with the set of compartments, the set of sensor devices comprising at least one of a set of ethylene gas detectors, a set of image capture devices, a set of weight sensors, a set of pressure sensors or a set of temperature sensors.

20. The configurable fruit ripening device of claim 17, further comprising:
a user interface device comprising a set of configuration controls, the user interface device receives a set of per-compartment fruit ripening configurations for customizing ripening of fruit in each compartment in the set of compartments via the set of configuration controls.
